(19) United States
(12) Patent Application Publication
(10) Pub. No.: US 2024/0228768 A1
(43) Pub. Date: Jul. 11, 2024

(54) REACTION CURABLE COMPOSITION

(71) Applicant: Panasonic Intellectual Property Management Co., Ltd., Osaka (JP)

(72) Inventors: Takahiro SENSHU, Mie (JP); Takeshi ISHIKAWA, Mie (JP); Takashi SARUWATARI, Mie (JP); Haruka FUJITA, Tokyo (JP); Yuki KOBAYASHI, Mie (JP)

(21) Appl. No.: 18/291,135

(22) PCT Filed: Jul. 25, 2022
(86) PCT No.: PCT/JP2022/028595

§ 371 Date: Jan. 22, 2024

Related U.S. Application Data
(60) Provisional application No. 63/227,139, filed on Jul. 29, 2021.

(51) Int. Cl. C08L 63/00; C09J 9/00; C09J 11/08; C09J 163/00

(52) U.S. Cl. CPC C08L 63/00; C09J 9/00; C09J 11/08; C09J 163/00; C08L 2205/14; C08L 2207/53

(57) ABSTRACT

A reaction curable composition according to an aspect of the present disclosure contains a reactive component (A) and a filler (B). The filler (B) contains an antireflection filler (B1). The antireflection filler (B1) has an average particle size of greater than or equal to 0.8 μm and less than or equal to 10 μm, and particles of the antireflection filler (B1) each have a surface having a plurality of projections. A mean diameter of the plurality of projections is greater than or equal to 100 nm and less than or equal to 500 nm.

### TECHNICAL FIELD

The present disclosure relates to reaction curable compositions and specifically relates to a reaction curable composition containing a reactive component and a filler.

### BACKGROUND ART

Patent Literature 1 discloses (a) a curable one-part epoxy resin composition including: an epoxy component including at least one epoxy compound including two or more groups per molecule; a latent curing agent component; a thixotropy-imparting component; a polythiol component including polythiol including at least one secondary or tertiary thiol group per molecule; and a stabilization component including solid organic acid, the curable one-pan epoxy resin composition optionally including a pigment, a filler, and the like.

### CITATION LIST

### Patent Literature

Patent Literature 1: JP 2014-500895 A

### SUMMARY OF INVENTION

It is an object of the present disclosure to provide a reaction curable composition configured to be cured to produce a cured material to suppress light from being reflected off a surface of the cured material.

A reaction curable composition according to an aspect of the present disclosure contains a reactive component (A) and a filler (B). The filler (B) contains an antireflection filler (B1). The antireflection filler (B1) has an average particle size of greater than or equal to 0.8 μm and less than or equal to 10 μm, and particles of the antireflection filler (B1) each have a surface having a plurality of projections. A mean diameter of the plurality of projections is greater than or equal to 100 nm and less than or equal to 500 nm.

### BRIEF DESCRIPTION OF DRAWINGS

FIG. 1 is a schematic sectional view of an example of a cured material of a reaction curable composition of an embodiment of the present disclosure;

FIG. 2 is a graph of a frequency of diameters of projections of particles of filler #1 (manufactured by NIKKO RICA CORPORATION, product name silcrusta MKN03);

FIG. 3 is a graph of a specular reflectance spectrum for each of cured materials of a plurality of types of compositions having different concentrations of filler #1 (manufactured by NIKKO RICA CORPORATION, product name Silcrusta MKN03);

FIG. 4 is a graph of a diffuse reflectance spectrum for each of the cured materials of the plurality of types of compositions having different concentrations of filler #1 (manufactured by NIKKO RICA CORPORATION, product name Silcrusta MKN03):

FIG. 5 is a graph of a total light reflectance spectrum for each of the cured materials of the plurality of types of compositions having different concentrations of filler #1 (manufactured by NIKKO RICA CORPORATION, product name Silcrusta MKN03);

FIG. 6 is an image obtained by capturing, with a differential scanning electron microscope, a surface of a cured material of a composition in which the concentration of filler #1 (manufactured by NIKKO RICA CORPORATION, product name Silcrusta MKN03) is 30 volume %; and

FIG. 7 is an image obtained by capturing, with the differential scanning electron microscope, particles of filler #1 (manufactured by NIKKO RICA CORPORATION, product name Silcrusta MKN03).

### DESCRIPTION OF EMBODIMENTS

First of all, how the inventors accomplished the present disclosure will be described.

As an adhesive, a sealing material, or the like, a reaction curable compound containing a reactive component and a filler may be used. For example, Patent Literature 1 (JP 2014-500895 A) discloses (a) a curable one-part epoxy resin composition including: an epoxy component including at least one epoxy compound including two or more groups per molecule; a latent curing agent component; a thixotropy-imparting component; a polythiol component including polythiol having at least one secondary or tertiary thiol group per molecule; and a stabilization component including solid organic acid, the curable one-part epoxy resin composition optionally including a pigment, a filler, and the like.

The inventors paid attention to that, for example, when the adhesive is used to manufacture an optical apparatus such as a camera module, and when the sealing material is used as, for example, an underfill material, a sidefill material, or a coating for an optical device such as an image sensor, light is specularly reflected off the adhesive and the sealing material, which may be a cause of noise.

Therefore, the inventors considered an anti-glare method and an anti-reflection method as a method for suppressing specular reflection of light at a surface of a cured material obtained by curing a composition.

According to research conducted by the inventors, the anti-glare method, however, has the following problems.

(1) In the case of an anti-glare method using a filler, an attempt to suppress the specular reflection of light by only a fine filler, or a combination of a large-diameter filler and the fine filler, readily increases the viscosity of the composition since the composition contains the filler(s). In particular, in a solventless case, the amount of the filler(s) has to be limited in order to suppress the viscosity from excessively increasing. Therefore, obtaining a great reflection suppressing effect is difficult.

(2) In the case of an anti-glare method using a phase separation method, controlling unevenness on a surface of a cured material is very difficult.

(3) In the case of an anti-glare method using shape transferring, postprocessing of a cured material is required, and therefore, simply curing the composition cannot suppress the specular reflection of light, and in particular, in the case of an adhesive for camera modules, the postprocessing is difficult.

Moreover, according to the research conducted by the inventors, the anti-reflection method has the following problems.

(1) In the case of an anti-reflection method using optical interference, a layered structure has to be imparted to a cured material, and therefore, complicated steps are necessary, and applying this method particularly to adhesive applications is difficult.

(2) In the case of an anti-reflection method by reducing the refractive index of a cured material, the refractive index of a cured material obtained by curing a composition including a reactive compound used for an adhesive or a sealing material such as, in particular, an epoxy compound or an acryl compound is still slightly below 1.4 though the refractive index is reduced, and a refractive index difference between the cured material and air is thus large, and therefore, satisfactorily reducing the reflection is difficult.

(3) In the case of an anti-reflection method using a continued pseudo-refractive index, a fine filler shorter than a wavelength of a visible right range like a moth eye structure may form unevenness of a surface of a cured material. However, an attempt to suppress the specular reflection of light by only a fine filler, or a combination of a large-diameter filler and the fine filler, readily increases the viscosity of the composition since the composition contains the filler(s). In particular, in a solventless case, the amount of the filler(s) has to be limited in order to suppress the viscosity from excessively increasing. Therefore, obtaining a great reflection suppressing effect is difficult.

Therefore, the inventors conducted intensive study and development to provide a reaction curable composition configured to be cured to produce a cured material to suppress light from being specularly reflected off a surface of the cured material even without an additional process such as postprocessing and thereby accomplished the present disclosure. Note that how the present disclosure was accomplished does not limit the contents of the present disclosure. That is, for example, the application of the reaction curable composition is not limited to only the adhesive and the sealing material and is not limited to only applications in which the specular reflection of light has to be suppressed.

An embodiment of the present disclosure will be described below. Note that the embodiment described below is a mere example of various embodiments of the present disclosure. The embodiment described below may be variously modified depending on design as long as the object of the present disclosure is achieved.

A reaction curable composition (hereinafter also referred to as a composition (X)) according to the present embodiment contains a reactive component (A) and a filler (B). The filler (B) contains an antireflection filler (B1). The antireflection filler (B1) has an average particle size of greater than or equal to 0.8 μm and less than or equal to 10 sm. Particles of the antireflection filler (B1) each have a surface having a plurality of projections. A mean diameter of the plurality of projections is greater than or equal to 100 nm and less than or equal to 500 nm.

Note that the antireflection filler (B1) is a filler satisfying the above-described condition for the particle size and having the above-described projections. The name “antireflection filler (B1)” is set only to distinguish the antireflection filler (B1) from another filler (B2), and the term “antireflection” in this name is not to specify the characteristic of the antireflection filler (B1).

According to the present embodiment, causing the reactive component (A) to react cures the composition (X), thereby obtaining a cured material. The cured material includes the antireflection filler (B1), and since the antireflection filler (B1) readily scatters light, the specular reflection of light at the surface of the cured material is effectively suppressed. Thus, in the present embodiment, producing the cured material from the composition (X) can suppress the specular reflection of light at the surface of the cured material.

Moreover, the antireflection filler (B1) scatters light very easily, and therefore, without excessively increasing the amount of the filler (B) in the composition (X), the specular reflection of light at the surface of the cured material can be suppressed. Thus, the amount of the filler (B) in the composition (X) is appropriately suppressed, thereby suppressing the viscosity from being increased by the filler (B) of the composition (X). Therefore, for example, also when the composition (X) contains no solvent, or the contained amount of the solvent in the composition (X) is small, the composition (X) can have good flowability.

Further, appropriately suppressing the amount of the filler (B) in the composition (X) can reduce the elastic modulus, and increase the percentage of elongation, of the cured material. This can increase impact resistance of the cured material.

Preferably, the composition (X) is of one-part type and is solventless, and a cured material thereof has satisfactorily excellent antireflection performance with respect to light having a wavelength in the visible light range. The cured material of the composition (X) preferably has satisfactorily excellent antireflection performance also with respect to light having a wavelength in a near infrared range (from 800 nm to 1000 nm). If the cured material has antireflection performance with respect to the light having the wavelength in the visible light range, using the composition (X), for example, as an adhesive in a camera module suppresses the reflection of visible light in the camera module, thereby suppressing noise such as flare noise in an image output from an image sensor or the like. Moreover, if the cured material has antireflection performance with respect to the light having the wavelength in the near infrared range, an image output from an image sensor or the like can be suppressed from discoloring. Therefore, in an optical path, in particular, in the camera module or the like, the light in the visible light range and the light in the infrared range is desirably not reflected. Note that the antireflection performance means performance capable of reducing the specular reflection of light.

Details of components of the composition (X) will be further described.

As described above, in the embodiment of the present disclosure, the composition (X) contains the reactive component (A) and the filler (B). The filler (B) contains the antireflection filler (B1). The antireflection filler (B1) has an average particle size of greater than or equal to 0.8 μm and less than or equal to 10 μm. A portion having an area of greater than or equal to 10% of the surface of each of the particles of the antireflection filler (B1) is preferably provided with projections having a mean diameter of greater than or equal to 100 nm and less than or equal to 500 nm. The mean diameter of the projections is an average value of projection diameters. The projection diameter is an average value of a longitudinal diameter (dimension of a long diameter) and a transverse diameter (dimension in a direction orthogonal to the long diameter) of the projection.

The reactive component (A) is a component which becomes a polymer by reaction. The reactive component (A) contains, for example, a reactive compound (A1), or the reactive compound (A1) and a curing agent (A2) which reacts with the reactive compound (A1).

The reactive compound (A1) contains, for example, at least one of an epoxy compound or an acryl compound.

The epoxy compound is preferably a compound including two or more epoxy groups per molecule. The epoxy compound contains, for example, at least one member selected from the group consisting of a biphenyl-type epoxy resin; a bisphenol-type epoxy resin such as a bisphenol A-type epoxy resin, a bisphenol F-type epoxy resin, and a bisphenol S-type epoxy resin; a hydrogenerated bisphenol-type epoxy resin such as a hydrogenerated bisphenol A-type epoxy resin, a hydrogenerated bisphenol F-type epoxy resin, and a hydrogenerated bisphenol S-type epoxy resin; a naphthalene ring-containing epoxy resin; an anthracene ring-containing epoxy resin; an alicyclic epoxy resin; a dicyclopentadiene-type epoxy resin; a phenol novolac-type epoxy resin; a cresol novolac-type epoxy resin; a triphenyl methane-type epoxy resin; a bromine-containing epoxy resin; an aliphatic-based epoxy resin; an aliphatic polyether-based epoxy resin; triglycidyl isocyanurate; a glycidyl group-containing silicone resin; a glycidyl amine-type epoxy resin, and the like.

The epoxy compound preferably includes the bisphenol-type epoxy resin, and more preferably includes at least one of the bisphenol A-type epoxy resin or the bisphenol F-type epoxy resin.

The acryl compound is a compound having at least one of an acryloyl group or a methacryloyl group in each molecule thereof. The acryl compound contains, for example, at least one member selected from the group consisting of trimethylol propane triacrylate, 1,6-hexane diol diacrylate, dimethylol-tricyclodecane diacrylate, acryloylmorpholine, tetrahydro furfuryl acrylate, 4-hydroxy butyl acrylate, 9,9-bis(4-(2-(meth)acryloyl oxyethoxy)phenyl)-9H-fluorene, tris-(2-acryloxyethyl)isocyanurate, bis-(2-acryloxyethyl)isocyanurate, caprolactone modified tris-(2-acryloxyethyl)isocyanurate, isocyanuric acid EO modified diacrylate, isocyanuric acid EO modified triacrylate, and the like.

The reactive compound (A1) is preferably in liquid form at 25° C. In this case, the viscosity of the composition (X) is further suppressed from increasing.

Compounds which the reactive compound (A1) may include are not limited to the epoxy compound and the acryl compound. For example, the reactive compound (A1) may contain an oxetane compound which is a compound including an oxetane group in each molecule thereof, a vinyl compound which is a compound including a vinyl group in each molecule thereof, and the like.

An example in which the reactive component (A) contains the curing agent (A2) will be described.

The curing agent (A2) contains a compound which can react with the reactive compound (A1). The curing agent (A2) includes, for example, at least one member selected from the group consisting of an amine compound, acid anhydride, a phenol compound, a thiol compound, and an imidazole compound. Preferably, the reactive compound (A1) contains the epoxy compound, and the curing agent (A2) contains, for example, at least one member selected from the group consisting of an amine compound, acid anhydride, a phenol compound, a thiol compound, and an imidazole compound. Also preferably, the reactive compound (A1) contains at least of the epoxy compound or the acryl compound, and the curing agent (A2) contains the thiol compound.

The amine compound is a compound including an amino group in each molecule thereof. The amine compound contains, for example, 4,4′-diamino-3,3′-diethyl diphenyl methane.

The acid anhydride contains, for example, one or more members selected from the group consisting of phthalic anhydride, trimellitic acid anhydride, pyromellitic anhydride, maleic anhydride, benzophenonetetracarboxylic anhydride, hexahydro phthalic anhydride, tetrahydro phthalic anhydride, methyl hexahydro phthalic anhydride, methyl tetrahydro phthalic anhydride, and polyazelaicpolyanhydride.

The phenol compound is a compound including a phenolic hydroxyl group in each molecule thereof. The phenol compound preferably includes two or more phenolic hydroxyl groups per molecule. The phenol compound contains, for example, one or more members selected from the group consisting of a phenol novolac resin, a cresol novolac resin, a biphenyl-type novolac resin, a triphenyl methane-type resin, a naphthol novolac resin, a phenol aralkyl resin, and a biphenyl aralkyl resin.

The thiol compound is a compound including a thiol group in each molecule thereof. The thiol compound contains, for example, pentaerythritol tetra (3-mercapto propionate) (e.g, product name EPOMATE QX40 manufactured by Mitsubishi Chemical Corporation).

The imidazole compound contains, for example, at least one member selected from the group consisting of 2-methylimidazole, 2-ethyl-4-methylimidazole, 2-phenyl imidazole, 2-phenyl-4-methylimidazole, and the like.

Note that also when the reactive compound (A1) contains a compound other than the epoxy compound, the curing agent (A2) may contain an appropriate compound in accordance with the kind of the compound included in the reactive compound (A1).

The content of the curing agent (A2) is, for example, greater than or equal to 0.3 equivalents and less than or equal to 1.5 equivalents relative to 1 equivalent of the reactive compound (A1).

The composition (X) may contain a curing catalyst. In this case, heating the composition (X) readily promotes a curing reaction of the composition (X). The curing catalyst contains, for example, at least one kind of component selected from the group consisting of imidazoles, cycloamidines, tertiary amines, organic phosphines, tetra-substituted phosphonium.tetra-substituted borate, quaternary phosphonium salt having a pairing anion other than the borate, tetraphenylboron salt, and the like. The curing catalyst may contain a latent curing catalyst. In this case, the composition (X) which is not heated is suppressed from reacting, thereby enhancing the preservation stability of the composition (X). The latent curing catalyst may contain at least one of a liquiform latent hardening accelerator or a solid-dispersible latent hardening accelerator. The latent curing catalyst may contain a microcapsule-type latent curing catalyst. The microcapsule-type latent curing catalyst contains, for example, microencapsulation imidazole including imidazoles as catalytically active compounds. The proportion of the curing catalyst is, for example, greater than or equal to 0.1% and less than or equal to 20% relative to the epoxy resin.

The composition (X) may contain an initiator (C). The initiator (C) is a compound which causes the reactive component (A) to start reacting. For example, when the reactive component (A) contains the acryl compound, the initiator (C) may contain a radical polymerization initiator. The radical polymerization initiator contains, for example, at least one kind of compound selected from the group consisting of aromatic ketones, an acylphosphine oxide compound, an aromatic onium salt compound, organic peroxide, a thio compound (a thioxanthone compound, a thiophenyl group-containing compound, etc.), a hexaarylbiimidazole compound, a ketoxime ester compound, a borate compound, an azinium compound, a metallocene compound, an active ester compound, a compound having a carbon-halogen bond, and an alkyl amine compound. The proportion of the initiator (C) is, for example, greater than or equal to 0.1% by mass and less than or equal to 10% by mass relative to the acryl compound.

Examples of a combination of the reactive compound (A1) and the curing agent (A2) or the initiator (C) include: a combination of the epoxy compound and the acid anhydride; a combination of the epoxy compound and the amine compound; a combination of the epoxy compound and the thiol compound; a combination of the epoxy compound and the phenol compound; a combination of the epoxy compound, the acryl compound, the thiol compound, and the initiator (C); and a combination of the epoxy compound, the acryl compound, the amine compound, and the initiator (C). Note that the combination of the reactive compound (A1) and the curing agent (A2) or the initiator (C) is not limited to the examples described above.

As described above, the reaction curable composition contains the filler (B), and the filler (B) contains the antireflection filler (B1).

As described above, the average particle size of the antireflection filler (B1) is greater than or equal to 0.8 μm and less than or equal to 10 μm. When the average particle size of the antireflection filler (B1) is greater than or equal to 0.8 μm, the viscosity of the composition (X) is less likely to be increased. When the average particle size is less than or equal to 10 μm, the flowability of the composition (X) can be secured, for example, when the composition (X) is caused to enter a narrow gap and when the composition (X) is discharged by dispensing. The average particle size is preferably greater than or equal to 1 sim, and more preferably greater than or equal to 1.5 μm. Moreover, the average particle size is preferably less than or equal to 5 μm, and more preferably less than or equal to 4 μm. Note that the average particle size is a median size calculated from a particle size distribution of a volume reference measured by laser diffraction scattering.

Moreover, when the mean diameter of the projections is greater than or equal to 100 nm and less than or equal to 500 nm, the antireflection filler (B1) effectively scatters the visible light, thereby imparting good antireflection performance to the cured material.

Note that the diameter of each projection is a value obtained by capturing an image of a particle of the antireflection filler (B1) with a differential scanning electron microscope, measuring the long diameter (longitudinal diameter) and a diameter (transverse diameter) orthogonal to the longitudinal diameter of each projection of the particle in the image thus obtained, and in addition, calculating an average value of the longitudinal diameter and the transverse diameter. Moreover, the mean diameter of the projections is an average value of the diameters of all projections in an image taken of 10 particles.

To more effectively scatter the visible light, the mean diameter of the projections of the antireflection filler (B1) is preferably greater than or equal to 200 nm. The mean diameter is more preferably greater than or equal to 400 nm. The mean diameter of the projections of the antireflection filler (B1) is also preferably less than or equal to 500 nm. In the distribution of the projection diameters of the antireflection filler (B1), the frequency in the range of from greater than or equal to 200 nm and less than or equal to 500 nm is preferably high. For example, the total number of projections having a diameter of greater than or equal to 200 nm and less than or equal to 500 nm is preferably 50% or more of the total number of projections. Moreover, a frequency distribution curve of the projection diameter preferably has a broad peak with constantly high frequency in the range of the projection diameter of greater than or equal to 200 nm and less than or equal to 400 nm, where the vertical axis represents the number of projections, and the horizontal axis represents the projection diameter. In this case, the projections of the antireflection filler (B1) can effectively scatter light having a wide wavelength range in the visible light range.

The antireflection filler (B1) is preferably provided with the projections in a portion having an area of greater than or equal to 10% of the surface of each of the particles thereof. In this case, the antireflection filler (B1) can impart better antireflection performance to the cured material. The surface of each particle in this case means the surface of each particle (hereinafter also referred to as a base particle), from which the projections have been removed, of the antireflection filler (B1). Saying that the projections are provided in a portion having an area of greater than or equal to 10% of the surface of each of the particles means that each of the particles of the antireflection filler (B1) is in such a shape as to have a plurality of projections attached to the surface of the base particle and a proportion (hereinafter also referred to as an attachment area proportion) of the total area of portions provided with the projections with respect to the surface of the base particle is greater than or equal to 10% of the total area of the surface of the base particle. The attachment area proportion is more preferably greater than or equal to 20%, and much more preferably greater than or equal to 30%. Moreover, the attachment area proportion is, for example, less than or equal to 100%, less than or equal to 95%, or less than or equal to 90%.

Note that the attachment area proportion can be determined by capturing an image with a differential scanning electron microscope and calculating the particle area and the projection area from the image thus captured.

Each of the particles of the antireflection filler (B1) is preferably a core shell-type particle including a core and a shell covering the core and has projections on a surface of the shell. That is, the base particle of each particle of the antireflection filler (B1) preferably include the core and the shell. In this case, a refractive index difference between the core and the shell may scatter light at an interface between the core and the shell. Therefore, the antireflection filler (B1) can more effectively scatter light.

The particles of the antireflection filler (B1) are preferably organic resin particles. Each of the core and the shell of each particle of the antireflection filler (B1) also preferably includes an organic resin. In these cases, the elastic modulus of the cured material of the composition (X) can be reduced, thereby enhancing impact resistance of the cured material.

The particles of the antireflection filler (B1) include at least one member selected from the group consisting of, for example, an acrylic resin such as polymethyl methacrylate (PMMA), a silicone resin, a styrene resin, a Melamine resin, a urethane resin, and the like. Moreover, when each particle of the antireflection filler (B1) is the core shell-type particle, each of the core and the shell includes at least one member selected from the group consisting of, for example, an acrylic resin such as polymethyl methacrylate (PMMA), a silicone resin, a styrene resin, a Melamine resin, a urethane resin, and the like.

When each particle of the antireflection filler (B1) is the core shell-type particle, for example, the core contains the acrylic resin such as polymethyl methacrylate (PMMA), and the shell and each projection contain the silicone resin. In this case, the antireflection filler (B1) more effectively scatters light, and the antireflection filler (B1) can further reduce the elastic modulus of the cured material.

When each particle of the antireflection filler (B1) is the core shell-type particle, the core may be a hollow. That is, each particle of the antireflection filler (B1) may be a hollow particle having a hollow and a shell defining the hollow.

Note that each particle of the antireflection filler (B1) does not have to be the core shell-type particle. That is, each particle of the antireflection filler (B1) may be homogeneous as a whole.

A refractive index of each particle of the antireflection filler (B1) preferably satisfies at least one of that the refractive index is less than or equal to 1.7 or that the refractive index is less than or equal to the refractive index of the cured material of the reactive component (A). In this case, a total light reflectance (i.e., a total of a diffuse reflectance and a specular reflectance) of the cured material of the composition (X) can be maintained or reduced. The refractive index of each particle of the antireflection filler (B1) is more preferably less than or equal to 1.6. The refractive index of each particle of the antireflection filler (B1) is also preferably greater than or equal to 1.3.

Note that the refractive index of each particle of the antireflection filler (B1) is, when each particle of the antireflection filler (B1) is homogeneous as a whole, the refractive index of a material of each particle, whereas when each particle of the antireflection filler (B1) is the core shell-type particle, the refractive index of the shell. Note that as in the case of the shell, a refractive index of the core preferably satisfies at least one of that the refractive index is less than or equal to 1.7 or that the refractive index is less than or equal to the refractive index of the cured material of the reactive component (A).

As the antireflection filler (B1), any commercially available product is usable. For example, the antireflection filler (B1) contains product name Silcrusta MKN03.

The filler (B) in the composition (X) may further contain a filler (B2) other than the antireflection filler (B1). When the filler (B2) other than the antireflection filler (B1) has an average particle size of greater than or equal to 100 nm and less than the average particle size of the antireflection filler (B1), the specular reflectance of the cured material of the composition (X) can be reduced. Note that even when the particle size of the filler (B2) other than the antireflection filler (B1) is greater than the above-mentioned range, the filler (B2) can reduce the specular reflectance of the cured material of the composition (X) if the filler (B2) partially dissolves at the curing of the composition (X) and the particle size of the filler (B2) in the cured material is thus small. Examples of the filler (B2) which can partially dissolve at the curing of the composition (X) include powdered polyamine (e.g., manufactured by ADEKA CORPORATION, product name EH-4357S). That is, even when the average particle size of the filler (B2) in the composition (X) is greater than the average particle size of the antireflection filler (B1), it is preferable if the average particle size of the filler (B2) in the composition (X) is greater than or equal to 100 nm and less than the average particle size of the antireflection filler (B1). The average particle size of the filler (B2) in the cured material is more preferably greater than or equal to 0.1 μm, and much more preferably greater than or equal to 0.2 μm. Moreover, the average particle size of the filler (B2) is more preferably less than or equal to 3 μm, and much more preferably less than or equal to 2 μm. The average particle size is a median size calculated from a particle size distribution of a volume reference measured by laser diffraction scattering. The filler (B2) may be fully dissolvable at the curing of the composition (X). In this case, the filler (B2), which has been fully dissolved, readily exposes the particles of the antireflection filler (B1) at the surface of the cured material, thereby further reducing the specular reflectance of the cured material, and the particles of the filler (B1) hardly inhibit a reduction in the total light reflectance of the cured material.

The shape of each particle of the filler (B2) is preferably an angulated shape such as a crushed shape. In this case, the filler (B2) can further reduce the specular reflectance of the cured material of the composition (X).

The filler (B2) may contain, for example, at least of a resin filler or an inorganic filler.

The inorganic filler contains, for example, at least one member selected from the group consisting of silica, alumina, barium sulfate, talc, clay, mica, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, and the like.

The resin filler can enhance the flexibility of the cured material. The resin filler contains, for example, at least one member selected from the group consisting of silicone powder, polystyrene powder, acrylic resin powder, benzo guanamine resin powder, polybutadiene powder, and powder including two or more kinds of the resins described above. Note that a resin which the resin filler may contain is not limited to the examples described above. The silicone powder contains, for example, at least one member selected from the group consisting of a pulverulent body including silicone rubber (silicone rubber powder), a pulverulent body including a silicone resin (silicone resin powder), and a pulverulent body including a core made of silicone rubber and a shell made of a silicone resin (silicone composite powder). Note that the silicone resin is silicone having a skeleton including a three-dimensional siloxane bond as a main body, and the silicone rubber is silicone having a skeleton including a two-dimensional siloxane bond as a main body.

The inorganic filler makes difficult cure shrinkage in the course of curing the composition (X) to produce the cured material. Therefore, the composition (X) is more suitable for adhesion of components in a precision instrument such as a camera module. The inorganic filler contains, for example, at least one member selected from the group consisting of silica, alumina, barium sulfate, talc, clay, mica, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, and the like.

When the filler (B) contains the filler (B2) other than the antireflection filler (B1), it is preferable that to reduce the elastic modulus of the cured material of the composition (X), the filler (B2) contain neither silica nor alumina or the content percentage of each of the silica and the alumina in the filler (B2) be low. Specifically, the proportion of a sum of the silica and the alumina relative to the composition (X) is preferably less than or equal to 10 volume %.

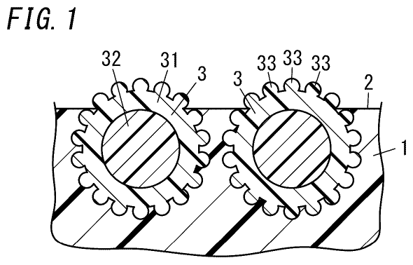

The proportion of the filler (B) inclusively of the antireflection filler (B1) relative to the composition (X) is preferably greater than or equal to 10 volume %. In this case, when the composition (X) is cured, cure shrinkage caused due to the reaction of the reactive component (A) can expose particles 3 of the antireflection filler (B1) at a surface of a cured material 1 (see FIG. 1). Thus, a light scattering action by the antireflection filler (B1) notably occurs, which can further reduce the specular reflectance of the cured material. The proportion of the filler (B) is more preferably greater than or equal to 20 volume %, and much more preferably greater than or equal to 25 volume %. Moreover, the proportion of the filler (B) is preferably less than or equal to 45 volume %. In this case, the viscosity of the filler (B) of the composition (X) can be suppressed from increasing. The proportion is more preferably less than or equal to 40 volume % and much more preferably less than or equal to 35 volume %.

The amount of the antireflection filler (B1) is preferably greater than or equal to 5 parts by mass and less than or equal to 82 parts by mass relative to 100 parts by mass of the reactive component (A). When the amount of the antireflection filler (B1) is greater than or equal to 5 parts by mass, the antireflection filler (B1) can in particular reduce the specular reflectance of light at the surface of the cured material. Moreover, when the amount of the antireflection filler (B1) is less than or equal to 82 parts by mass, the viscosity of the antireflection filler (B1) of the composition (X) is suppressed from increasing. The amount of the antireflection filler (B1) is more preferably greater than or equal to 5 volume %, and much more preferably greater than or equal to 25 volume %. Moreover, the amount is more preferably less than or equal to 66 volume %, and much more preferably less than or equal to 43 volume %.

The composition (X) preferably further contains a coloring material (D). In this case, light is absorbed by the coloring material (D) in the cured material of the composition (X), thereby further reducing the specular reflectance and the total reflectance of the cured material.

The coloring material (D) preferably contains at least one member selected from the group consisting of carbon black, black titanium oxide, zirconium nitride, and a dye. In this case, the specular reflectance and the total light reflectance of the cured material are more easily reduced. That is, the coloring material (D) reduces a transmittance of the cured material, thereby suppressing light entering the cured material from being reflected off the interface between the cured material and a member (e.g., an adherend) in contact with the cured material and coming outward from the curd material.

An average transmittance of the cured material of the composition (X) for light in the wavelength range from 400 nm to 800 nm is preferably less than or equal to 10% and more preferably less than or equal to 1%. When the transmittance is less than or equal to 1%, the light entering the cured material and reflected off the adherend or the like and coming outward from the cured material exerts almost no influence over the specular reflectance of the cured material.

When the composition (X) contains the coloring material (D), the amount of the coloring material (D) is preferably greater than 0 parts by mass and less than or equal to 10 parts by mass relative to 100 parts by mass of the reactive component (A). The amount of the coloring material (D) is more preferably greater than or equal to 0.1 parts by mass, and much more preferably greater than or equal to 0.3 parts by mass. Moreover, the amount of the coloring material (D) is more preferably less than or equal to 8 parts by mass, and much more preferably less than or equal to 5 parts by mass.

The composition (X) may further contain an additive other than the above examples as long as the effect of the present embodiment is not excessively impaired. The additive includes, for example, at least one member selected from the group consisting of a polymerization inhibitor, a radical scavenger, a diluent, a flexibility-imparting agent, a coupling agent, an antioxidant, a thixotropy-imparting agent, a dispersant, and the like.

The composition (X) preferably contains no solvent or contains only a solvent inevitably mixed therewith as a solvent. When the composition (X) contains a solvent, the proportion of the solvent relative to the composition (X) is preferably less than or equal to 0.1% by mass. In this case, the composition (X) can be suitably used as an adhesive or can be suitably used to produce an underfill material. Moreover, in the present embodiment, the antireflection performance of the cured material of the composition (X) can be enhanced while the viscosity of the filler (B) of the composition (X) is suppressed from increasing, and therefore, the composition (X) contains no solvent or the content of the solvent in the composition (X) is small, and thereby, the composition (X) can have good flowability, and thus, the coating properties and the moldability of the composition (X) are improved.

The viscosity of the composition (X) at 25° C. measured with a B-type rotary viscometer at a rotational velocity of 20 rpm is preferably less than or equal to 200 Pa·s. In this case, the composition (X) can have particularly good coating properties and moldability. Moreover, as described above, in the present embodiment, the antireflection performance of the cured material of the composition (X) can be enhanced while the viscosity of the filler (B) of the composition (X) is suppressed from increasing, and therefore, a low viscosity of the composition (X) can be achieved as described above. The viscosity is more preferably less than or equal to 100 Pa·s, and much more preferably less than or equal to 50 Pa·s. Moreover, the viscosity is, for example, greater than or equal to 2 Pa·s.

Moreover, a thixotropic index (10 rpm viscosity/100 rpm viscosity) which is a ratio of the viscosity of the composition (X) at 25° C. measured with the B-type rotary viscometer at a rotational velocity of 2 rpm to the viscosity at 25° C. measured with the B-type rotary viscometer at a rotational velocity of 20 rpm is preferably greater than or equal to 1 and less than or equal to 7. In this case, the composition (X) can have particularly good flowability, the composition (X) can be more suitably used as an adhesive, or can be more suitably used to produce an underfill material. In particular, in this case, the composition (X) can be suitably used to produce an underfill material for image sensors. In the present embodiment, the antireflection performance of the cured material of the composition (X) can be enhanced while the viscosity of the filler (B) of the composition (X) is suppressed from increasing, and therefore, the thixotropic index described above can be achieved. The thixotropic index is more preferably greater than or equal to 1.5, and much more preferably greater than or equal to 1.8. Moreover, the thixotropic index is more preferably less than or equal to 5.0, and much more preferably less than or equal to 4.0.

The composition (X) is cured, thereby obtaining a cured material. In this case, any method according to the composition of the reactive component (A) contained in the composition (X), and the compositions of the initiator (C), a catalyst, and the like optionally contained in the composition (X), causes the reactive component (A) to react, thereby curing the composition (X). For example, the composition (X) can be cured by heating. Moreover, when the composition (X) contains the initiator (C), irradiating the composition (X) with light such as ultraviolet light can cure the composition (X), and further heating the composition (X) after the composition (X) is irradiated with the light can also cure the composition (X).

FIG. 1 schematically shows an example of the cured material 1 of the composition (X). Before the composition (X) cures, the particles 3 of the antireflection filler (B2) are embedded in the composition (X), but when the composition (X) cures, the reaction of the reactive component (A) causes cure shrinkage, and therefore, the particles 3 of the antireflection filler (B2) are exposed at a surface 2 of the cured material 1. In the example shown in FIG. 1, each particle 3 is a core shell-type particle including a core 32 and a shell 31, and each particle 3 has a surface having a plurality of projections 33. As described above, the projections 33 provide fine unevenness to the surface 2 of the cured material 1, light diffusion reflection thus readily occurs at the surface 2 of the cured material 1, and the total light reflectance itself of the surface 2 can also be reduced. Thus, the specular reflectance of light at the cured material 1 decreases. Moreover, as described above, when each particle 3 is the core shell-type particle, the refractive index difference between the core 32 and the shell 31 readily causes light diffusion reflection at the interface between the core 32 and the shell 31, and thus, the specular reflectance of light is readily further reduced. Moreover, as described above, when the average particle size of the antireflection filler (B1) is greater than or equal to 0.8 μm, the viscosity of the composition (X) is hardly increased, and when the average particle size is less than or equal to 10 μm, the flowability of the composition (X) in, for example, underfill material manufacturing applications can be ensured.

The average specular reflectance, measured by using an integrating sphere and at an incidence angle of 8, of the cured material of the composition (X) for light in a wavelength range of greater than or equal to 400 nm and less than or equal to 800 nm is preferably less than or equal to 0.5%, and more preferably less than or equal to 0.2%. The average specular reflectance, measured by the method described above, for light in a wavelength range of greater than or equal to 800 nm and less than or equal to 1000 nm is also preferably less than or equal to 0.5%, and more preferably less than or equal to 0.2%. The average specular reflectance, measured by the method described above, for light in a wavelength range of greater than or equal to 400 nm and less than or equal to 1000 nm is also preferably less than or equal to 0.5%, and more preferably less than or equal to 0.2%. In these cases, the specular reflection of light at the cured material can in particular be reduced. Thus, when the cured material of the composition (X) is applied to an optical apparatus, noise caused due to light reflected off the cured material can be reduced. In the present embodiment, such a low average specular reflectance can be achieved. In addition, a low diffuse reflectance at the cured material of the composition (X) is also preferable for noise reduction.

The elastic modulus (storage elastic modulus) of the cured material of the composition (X) at −40° C. is preferably less than or equal to 10 GPa. In this case, the cured material of the composition (X) readily has good impact resistance, and therefore, the composition (X) can be particularly suitably used as an adhesive for camera modules. Note that the elastic modulus at −40° C. being less than or equal to 10 GPa means that the elastic modulus at or under a glass transition temperature of the cured material is low. In the present embodiment, such a low elastic modulus of the cured material can be achieved. This elastic modulus is more preferably less than or equal to 6 GPa, and much more preferably less than or equal to 5 GPa. Moreover, the elastic modulus is, for example, greater than or equal to 1 GPa. Note that a method for measuring the elastic modulus will be described in the later-described examples.

As described above, the composition (X) is appropriate, for example, as an adhesive, and is more specifically, for example, appropriate as an adhesive for bonding constituting members of an optical apparatus such as a camera module to each other. In this case, even when a surface of an end or the like of the cured material of the composition (X) bonding the constituting members to each other is exposed outside, the specular reflection of light at this surface is suppressed. Thus, in an optical apparatus such as a camera module, noise is suppressed from being caused due to light reflected off a surface of an adhesive. A material for the constituting members to be bonded to each other by the composition (X) is, for example, but not limited to, a resin material such as liquid crystal polymer, polycarbonate, polyester, and polyimide, metal such as nickel and copper, ceramic, glass, or other various types of substrate materials. When the composition (X) is used as an adhesive, for example, the composition (X) lying between two constituting components is cured as described above by an appropriate method, thereby bonding the constituting components to each other.

As described above, the composition (X) is also suitably used to produce an underfill material. The underfill material is a sealing material for sealing a gap between a base member such as a printed wiring board and a mounted component mounted on the base member. When the mounted component is an optical device such as an image sensor, the composition (X) can particularly appropriately be used. In this case, even when a surface of an end or the like of the underfill material is exposed outside, the specular reflection of light at the surface is suppressed, and thereby, noise is suppressed from being caused due to light specularly reflected off the surface of the underfill material in the optical device. When the underfill material is made of the composition (X), the composition (X) is injected into a gap, for example, between the base member and the mounted component mounted on the base member, and then, the composition (X) is cured by an appropriate method as described above.

### Summary

A reaction curable composition of a first aspect of the present disclosure contains a reactive component (A) and a filler (B). The filler (B) contains an antireflection filler (B1). The antireflection filler (B1) has an average particle size of greater than or equal to 0.8 μm and less than or equal to 10 μm, and particles of the antireflection filler (B1) each have a surface having a plurality of projections. A mean diameter of the plurality of projections is greater than or equal to 100 nm and less than or equal to 500 nm.

With this aspect, the reaction curable composition is cured to produce a cured material, thereby suppressing light from being reflected off a surface of the cured material.

In a second aspect referring to the first aspect, the antireflection filler (B1) is provided with the plurality of projections in a portion having an area of greater than or equal to 10% of the surface of each of the particles of the antireflection filler (B1).

In a third aspect referring to the first or second aspect, the reactive component (A) contains a reactive compound (A1), and the reactive compound (A1) contains at least one of an epoxy compound or an acryl compound.

In a fourth aspect referring to the third aspect, the reactive component (A) further contains a curing agent (A2) which reacts with the reactive compound (A1).

A fifth aspect referring to the third or fourth aspect further containing an initiator (C).

In a sixth aspect referring to any one of the first to fifth aspects a refractive index of the antireflection filler (B1) satisfies at least one of that the refractive index is less than or equal to 1.7 or that the refractive index of the antireflection filler (B1) is less than or equal to a refractive index of a cured material of the reactive component (A).

In a seventh aspect referring to any one of the first to sixth aspects, each of the particles of the antireflection filler (B1) is a core shell-type particle including a core and a shell covering the core and has the plurality of projections on a surface of the shell.

In an eighth aspect referring to the seventh aspect, the core contains an acrylic resin, and the shell and each of the plurality of projections contain silicone.

In a ninth aspect referring to any one of the first to eighth aspects, a percentage of the filler (B) relative to the reaction curable composition is greater than or equal to 10 volume %.

In a tenth aspect referring to any one of the first to ninth aspects, an amount of the antireflection filler (B1) relative to 100 parts by mass of the reactive component (A) is greater than or equal to 5 parts by mass and less than or equal to 82 parts by mass.

In an eleventh aspect referring to any one of the first to tenth aspects, the reaction curable composition further contains a coloring material (D).

In a twelfth aspect, the coloring material contains at least one member selected from the group consisting of carbon black, black titanium oxide, zirconium nitride, and a dye.

In a thirteenth aspect referring to the eleventh or twelfth aspect, an amount of the coloring material (D) relative to 100 parts by mass of the reactive component (A) is greater than 0 parts by mass and less than or equal to 10 parts by mass.

In a fourteenth aspect referring to any one of the first to thirteenth aspects, an average specular reflectance, measured by using an integrating sphere and at an incidence angle of 8°, of a cured material of the reaction curable composition for light in a wavelength range of greater than or equal to 400 nm and less than or equal to 800 nm is less than or equal to 0.5%.

In a fifteenth aspect referring to any one of the first to fourteenth aspects, a viscosity at 25° C., measured with a B-type rotary viscometer at 20 rpm, of the reaction curable composition is less than or equal to 200 Pa·s.

In a sixteenth aspect referring to any one of the first to fifteenth aspects, a thixotropic index which is a ratio of a viscosity at 25° C., measured with a B-type rotary viscometer at 2 rpm, of the reaction curable composition to a viscosity at 25° C. measured with the B-type rotary viscometer at 20 rpm is greater than or equal to 1 and less than or equal to 7.

In a seventeenth aspect referring to any one of the first to sixteenth aspects, an elastic modulus of a cured material of the reaction curable composition at −40° C. is less than or equal to 10 GPa.

In an eighteenth aspect referring to anyone of the first to seventeenth aspects, the reaction curable composition contains no solvent or contains only a solvent inevitably mixed with the reaction curable composition as a solvent.

In a nineteenth aspect referring to any one of the first to eighteenth aspects, the reaction curable composition is an adhesive.

In a twentieth aspect referring to anyone of first to eighteenth aspects, the reaction curable composition is a composition for underfill material production.

### Examples

More specific examples of the present embodiment will be presented below. Note that the present embodiment is not limited to the examples below.

### 1. Preparation of Composition

Raw materials shown in Tables 1 to 4 were mixed with each other, thereby preparing compositions. Details of the raw materials shown in Tables 1 to 4 are as indicated below.
YD8125: A liquiform bisphenol A-type epoxy resin. Manufactured by NIPPON STEEL Chemical & Material Co., Ltd., product name YD8125. Specific gravity 1.2.
YDF8170: A liquiform bisphenol F-type epoxy resin. Manufactured by NIPPON STEEL Chemical & Material Co., Ltd., product name YDF8170. Specific gravity 1.2.
#230: 1,6-hexane diol diacrylate. Manufactured by OSAKA ORGANIC CHEMICAL INDUSTRY LTD. Product name Viscoat #230. Specific gravity 1.02.
MH-700: Liquiform acid anhydride. Manufactured by New Japan Chemical Co, Ltd., product name RIKACID MH-700. Specific gravity 1.2.
EH-4357S: Powdered polyamine. Manufactured by ADEKA CORPORATION, product name EH-4357S. Specific gravity 1.2.
QX40: A liquiform thiol compound. Manufactured by Mitsubishi Chemical Corporation. Pentaerythritol tetra (3-mercapto propionate). Product name Epomate QX40. Specific gravity 1.26.
MEH8000H: A liquiform allylation phenol novolac resin. Manufactured by MEIWA PLASTIC INDUSTRIES, LTD., product name MEH8000H. Specific gravity 1.2.
Omnirad 184: 1-hydroxy cyclohexyl-phenyl ketone. Manufactured by IGM Resins B. V., product name Omnirad 184. Specific gravity 1.2.
2P4MZ: 2-phenyl-4-methylimidazole. Manufactured by Shikoku Chemicals Corporation. Specific gravity 1.1.
HXA9322HP: Microencapsulation imidazole. Manufactured by ASAHI KASEI E-materials Corp., product name NOCACURE HXA9322HP.
Filler #1: Core shell-type particles each having projections on a surface thereof, each including a core made of polymethylmethacrylate and a shell made of a silicone resin. Average particle size 3 μm. Projection diameter 0.2 to 0.4 jun. Average projection diameter 0.3 μm. Attachment area proportion of projections 60%. Manufactured by NIKKO RICA CORPORATION, product name Silcrusta MKN03. Specific gravity 1.2.
Filler #2: Spherical silica. Average particle size 0.3 μm. Manufactured by ADMATECHS COMPANY LIMITED, product name SC1053SQ. Specific gravity 2.2.
Filler #3: Spherical silicone powder. Manufactured by NIKKO RICA CORPORATION, product name MSP-SN08. Average particle size 0.8 μm. Specific gravity 1.2.
Filler #4: Silicone powder having a surface provided with projections. Average particle size 4 μm. Projection diameter less than or equal to 0.1 μm. Average projection diameter less than or equal to 0.1 μm. Manufactured by NIKKO RICA CORPORATION, product name MSPTKN04. Specific gravity 1.2.
Filler #5: Silicone powder having a surface provided with projections. Average particle size 6 μm. Projection diameter greater than or equal to 0.4 μm, average projection diameter 0.6 μm. Manufactured by NIKKO RICA CORPORATION, product name NHRASN06. Specific gravity 1.2.
Filler #6: Spherical silica. Average particle size 1.0 μm. Manufactured by ADMATECHS COMPANY LIMITED, product name SC4053SQ. Specific gravity 2.2.
MA600MJ2: Carbon Black. Average particle size 20 nm. Manufactured by Mitsubishi Chemical Corporation, product name MA600MJ2. Specific gravity 1.8.
UF-8: Black titanium oxide. Average particle size 20 nm. Manufactured by Mitsubishi Materials Electronic Chemicals Co., Ltd. Product name UF-8. Specific gravity 3.9.

### 2. Evaluation Test

The compositions were subjected to an evaluation test described below. Results of the evaluation test are shown in Tables 1 to 4.

### (1) Production of Cured Material

Each of the compositions was applied to a glass slide, thereby producing a film having a dimension of 20 mm×50 mm×0.2 mm.

In each of Examples 1 to 10 and Comparative Examples 15 to 20, the film was cured by heating, thereby obtaining a cured material. The temperature and time at the time of the heating were 120° C. and 3 hours in each of Examples 1 and 2 and Comparative Examples 15 to 20, 80° C. and 1 hour in each of Examples 3 to 8, and 120° C. and 3 hours in each of Examples 9 and 10.

In each of Example 11 and 12, the film was cured by heating following irradiation with ultraviolet light, thereby obtaining a cured material. Conditions for the irradiation with the ultraviolet light were a wavelength of 365 nm, an illuminance of 500 mW/cm², and an accumulated light quantity of 2000 mJ/cm². The temperature and time at the time of heating were 80° C. and 1 hour.

In each of Examples 13 and 14, the film was cured by irradiating with ultraviolet light, thereby obtaining a cured material. Conditions for the irradiation with the ultraviolet light were a wavelength of 365 nm, an illuminance of 500 mW/cm², and an accumulated light quantity of 2000 mJ/cm².

### (2) Viscosity at 25° C.

By using a B-type rotary viscometer (manufactured by TOKI SANGYO CO., LTD, model number TVB-10), the viscosity of each composition at 25° C. was measured at a rotational velocity of 20 rpm.

### (3) Thixotropic Index at 25° C.

By using the B-type rotary viscometer (manufactured by TOKI SANGYO CO., LTD, model number TVB-10), the viscosity of each composition at 25° C. was measured at a rotational velocity of 2 rpm. From this result and the viscosity obtained in “(1) Viscosity at 25° C.”, a thixotropic index (2 rpm viscosity/20 rpm viscosity) which is a ratio of a viscosity at 25° C. measured at a rotational velocity of 2 rpm to a viscosity at 25° C. measured at a rotational velocity of 20 rpm was calculated.

### (4) 400-800 nm Average Specular Reflectance

The cured material produced in “(1) Production of Cured Material” was used as an evaluation sample, and for this evaluation sample, a total light reflectance at an incidence angle of 8° and a diffuse reflectance at an incidence angle of 0° were measured with spectral photometer UV-3600i Plus manufactured by Shimadzu Corporation. A difference between the total light reflectance and the diffuse reflectance was calculated as specular reflectance. From the result, an average value of specular reflectance in a wavelength range of 400-800 nm was obtained as an average specular reflectance.

### (5) 800-1000 nm Average Specular Reflectance

The cured material produced in “(1) Production of Cured Material” was used as an evaluation sample, and for this evaluation sample, a total light reflectance at an incidence angle of 8° and a diffuse reflectance at an incidence angle of 0° were measured with spectral photometer UV-3600i Plus manufactured by Shimadzu Corporation, and a difference between the total light reflectance and the diffuse reflectance was calculated as specular reflectance. From the result, an average value of specular reflectance in a wavelength range of 800-1000 nm was obtained as an average specular reflectance.

### (6) 400-800 nm Average Diffuse Reflectance

The cured material produced in “(1) Production of Cured Material” was used as an evaluation sample, and for this evaluation sample, a diffuse reflectance at an incidence angle of 0° were measured with spectral photometer UV-3600i Plus manufactured by Shimadzu Corporation. From the result, an average value of diffuse reflectance in a wavelength range of 400-800 nm was obtained as an average diffuse reflectance.

### (7) 800-1000 nm Average Diffuse Reflectance

The cured material produced in “(1) Production of Cured Material” was used as an evaluation sample, and for this evaluation sample, a diffuse reflectance at an incidence angle of 0° were measured with spectral photometer UV-3600i Plus manufactured by Shimadzu Corporation. From the result, an average value of diffuse reflectance in a wavelength range of 800-1000 nm was obtained as an average diffuse reflectance.

### (8) 400-1000 nm Average Transmittance

The cured material produced in “(1) Production of Cured Material” was used as an evaluation sample, and for this evaluation sample, a transmittance of light at an incidence angle of 0° were measured with spectral photometer UV-3600i Plus manufactured by Shimadzu Corporation. From the result, an average value of the transmittance in a wavelength range of 400-1000 nm was obtained as an average transmittance.

### (9) Adhesion Force

Adhesion force when the composition is used as an adhesive was measured by the following method. To an adherend made of glass, the composition was applied to produce a coating film having a diameter of 3 mm and a thickness of 0.5 mm. The coating film was cured under the same condition as that in “(1) Production of Cured Material”, thereby obtaining a cured material. By using a shear tester, shear bond strength of the cured material with respect to the adherend was measured.

Based on the result, the adhesion force was evaluated in accordance with the following criteria.
A: Greater than or equal to 15 MPa.
B: Greater than or equal to 5 MPa and less than 15 MPa.
C: Less than 5 MPa.

### (10) Elastic Modulus

On a glass pane, a release film made of polyethylene terephthalate was disposed, and on the release film, a spacer made of silicone, having a size of 3 mm×50 mm in plan view and having a space of a thickness of 0.5 mm was disposed. Into the space in the spacer, the composition was poured, and then, on an upper surface of the spacer, a release film made of a polyethylene terephthalate was disposed, and on the release film, a glass pane was disposed. Subsequently, the composition was cured under the same condition as that in “(1) Production of Cured Material”, thereby producing an evaluation sample.

A storage elastic modulus of the evaluation sample at −40° C. was measured with viscoelastic measurement device DMA7100 manufactured by Hitachi High-Tech Science Corporation at a measurement frequency of 1 Hz and in a measurement mode set to tension and was evaluated in accordance with the following criteria.
A: Greater than or equal to 1 GPa and less than 4 GPa.
B: Greater than or equal to 4 GPa and less than 7 GPa.
C: Greater than or equal to 7 GPa.

TABLE 1

| | | Example | | | | | | |
|---|---|---|---|---|---|---|---|---|
| | | 1 | 2 | 3 | 4 | 5 | 6 | 7 |
| Reactive | YD8125 | 21 | 21 | 33 | 33 | 33 | 21 | 21 |
| Compound | YDF8170 | 21 | 21 | 33 | 33 | 33 | 21 | 21 |
| (part by mass) | #230 | | | | | | | |
| Curing Agent | MH-700 | 57 | 57 | | | | | |
| (part by mass) | EH-4357S | | | 11 | 11 | 11 | | |
| | QX40 | | | | | | 32 | 32 |
| | MEH8000H | | | | | | | |
| Initiator | OMNIRAD 184 | | | | | | | |
| (part by mass) | | | | | | | | |
| Catalyst | 2P4MZ | 1 | 1 | | | | | |
| (part by mass) | HXA9322HP | | | 23 | 23 | 23 | 26 | 26 |
| Filler | Filler #1 | 43 | 66 | 5 | 25 | 66 | 5 | 25 |
| (part by mass) | Filler #2 | | | | | | | |
| | Filler #3 | | | | | | | |
| | Filler #4 | | | | | | | |
| | Filler #5 | | | | | | | |
| | Filler #6 | | | | | | | |
| Pigment | MA600MJ2 | 1 | 1 | 1 | 1 | 1 | 1 | 1 |
| (part by mass) | UF-8 | | | | | | | |
| Volume Percent of Total Antireflection Filler | | 30% | 40% | 5% | 20% | 40% | 5% | 20% |
| Volume Percent of Total Filler | | 30% | 40% | 23% | 35% | 51% | 13% | 27% |
| Evaluation | Viscosity at 25° C.(Pa · s) | 7 | 35 | 3 | 7 | 150 | 3 | 15 |
| | Thixotropic Index | 1.5 | 2.0 | 1.9 | 2.1 | 2.6 | 1.1 | 1.2 |
| | 400-800 nm Average | <0.2 | <0.2 | 0.3 | <0.2 | <0.2 | 0.3 | <0.2 |
| | Specular Reflectance (%) | | | | | | | |
| | 800-1000 nm Average | <0.2 | <0.2 | 0.45 | <0.2 | <0.2 | 0.45 | <0.2 |
| | Specular Reflectance (%) | | | | | | | |
| | 400-800 nm Average | 4.7 | 3.2 | 5.5 | 4.5 | 3.8 | 5.7 | 4.5 |
| | Diffuse Reflectance (%) | | | | | | | |
| | 800-1000 nm Average | 4.6 | 3.1 | 5.5 | 4.4 | 3.7 | 5.7 | 4.4 |
| | Diffuse Reflectance (%) | | | | | | | |
| | 400-1000 nm Average | <0.1 | <0.1 | <0.1 | <0.1 | <0.1 | <0.1 | <0.1 |
| | Transmittance (%) | | | | | | | |
| | Adhesion Force (MPa) | A | B | A | A | B | A | A |
| | Elastic Modulus (GPa) | B | B | B | B | B | A | B |

TABLE 2

| | | Example | | | | | | |
|---|---|---|---|---|---|---|---|---|
| | | 8 | 9 | 10 | 11 | 12 | 13 | 14 |
| Reactive | YD8125 | 21 | 27 | 27 | 17 | 17 | | |
| Compound | YDF8170 | 21 | 27 | 27 | 17 | 17 | | |
| (part by mass) | #230 | | | | 19 | 19 | 51.8 | 51.8 |
| Curing Agent | MH-700 | | | | | | | |
| (part by mass) | EH-4357S | | | | | | | |
| | QX40 | 32 | | | 38.8 | 38.8 | 47.6 | 47.6 |
| | MEH8000H | | 45 | 45 | | | | |
| Initiator | OMNIRAD 184 | | | | 1.2 | 1.2 | 0.6 | 0.6 |
| (part by mass) | | | | | | | | |
| Catalyst | 2P4MZ | | 1 | 1 | | | | |
| (part by mass) | HXA9322HP | 26 | | | 7 | 7 | | |
| Filler | Filler #1 | 66 | 43 | 66 | 43 | 66 | 43 | 82 |
| (part by mass) | Filler #2 | | | | | | | |
| | Filler #3 | | | | | | | |
| | Filler #4 | | | | | | | |
| | Filler #5 | | | | | | | |
| | Filler #6 | | | | | | | |
| Pigment | MA600MJ2 | 1 | 1 | 1 | | | | |
| (part by mass) | UF-8 | | | | 1 | 1 | 1 | 1 |
| Volume Percent of Total Antireflection Filler | | 40% | 30% | 40% | 30% | 40% | 30% | 45% |
| Volume Percent of Total Filler | | 45% | 30% | 40% | 32% | 41% | 30% | 45% |
| Evaluation | Viscosity at 25° C.(Pa · s) | 50 | 15 | 50 | 5 | 120 | 3 | 10 |
| | Thixotropic Index | 1.5 | 1.2 | 1.5 | 1.6 | 2.1 | 2.9 | 4.5 |
| | 400-800 nm Average | <0.2 | <0.2 | <0.2 | <0.2 | <0.2 | <0.2 | <0.2 |
| | Specular Reflectance (%) | | | | | | | |
| | 800-1000 nm Average | <0.2 | <0.2 | <0.2 | <0.2 | <0.2 | <0.2 | <0.2 |
| | Specular Reflectance (%) | | | | | | | |
| | 400-800 nm Average | 3.3 | 5.1 | 3.5 | 5 | 4.2 | 3.5 | 2.4 |
| | Diffuse Reflectance (%) | | | | | | | |
| | 800-1000 nm Average | 3.2 | 5 | 3.4 | 5 | 4.1 | 3.5 | 2.4 |
| | Diffuse Reflectance (%) | | | | | | | |
| | 400-1000 nm Average | <0.1 | <0.1 | <0.1 | 2 | 2 | 2 | 2 |
| | Transmittance (%) | | | | | | | |
| | Adhesion Force (MPa) | B | A | B | A | A | B | B |
| | Elastic Modulus (GPa) | B | B | B | A | A | A | A |

TABLE 3

| | | Comparative Example | | | | | |
|---|---|---|---|---|---|---|---|
| | | 15 | 16 | 17 | 18 | 19 | 20 |
| Reactive | YD8125 | 21 | 21 | 21 | 21 | 21 | 21 |
| Compound | YDF8170 | 21 | 21 | 21 | 21 | 21 | 21 |
| (part by mass) | #230 | | | | | | |
| Curing Agent | MH-700 | 57 | 57 | 57 | 57 | 57 | 57 |
| (part by mass) | EH-4357S | | | | | | |
| | QX40 | | | | | | |
| | MEH8000H | | | | | | |
| Initiator | OMNIRAD 184 | | | | | | |
| (part by mass) | | | | | | | |
| Catalyst | 2P4MZ | 1 | 1 | 1 | 1 | 1 | 1 |
| (part by mass) | HXA9322HP | | | | | | |
| Filler | Filler #1 | 0 | | | | | |
| (part by mass) | Filler #2 | | 79 | | | | |
| | Filler #3 | | | 43 | | | |
| | Filler #4 | | | | 43 | | |
| | Filler #5 | | | | | 43 | |
| | Filler #6 | | | | | | 79 |
| Pigment | MA600MJ2 | 1 | 1 | 1 | 1 | 1 | 1 |
| (part by mass) | UF-8 | | | | | | |
| Volume Percent of Total Antireflection Filler | | 0% | 0% | 0% | 0% | 0% | 0% |
| Volume Percent of Total Filler | | 0% | 30% | 30% | 30% | 30% | 55% |
| Evaluation | Viscosity at 25° C.(Pa · s) | 3 | 250 | 20 | 9 | 6 | 16 |
| | Thixotropic Index | 2.1 | 1.8 | 1.3 | 1.7 | 1.5 | 1.3 |
| | 400-800 nm Average | 3.6 | 2.6 | 2.5 | 2.2 | 1.7 | 2.6 |
| | Specular Reflectance (%) | | | | | | |
| | 800-1000 nm Average | 3.8 | 2.9 | 2.8 | 2.5 | 2 | 2.9 |
| | Specular Reflectance (%) | | | | | | |
| | 400-800 nm Average | 3.1 | 3.4 | 3.5 | 3.8 | 4.3 | 3.4 |
| | Diffuse Reflectance (%) | | | | | | |
| | 800-1000 nm Average | | 3.1 | 3.2 | 3.5 | 4 | 3.1 |
| | Diffuse Reflectance (%) | | | | | | |
| | 400-1000 nm Average | <0.1 | <0.1 | <0.1 | <0.1 | <0.1 | <0.1 |
| | Transmittance (%) | | | | | | |
| | Adhesion Force (MPa) | A | B | B | B | B | B |
| | Elastic Modulus (GPa) | B | C | B | B | B | C |

### 3. Additional Evaluation

### (1) Evaluation of Projection of Filler #1

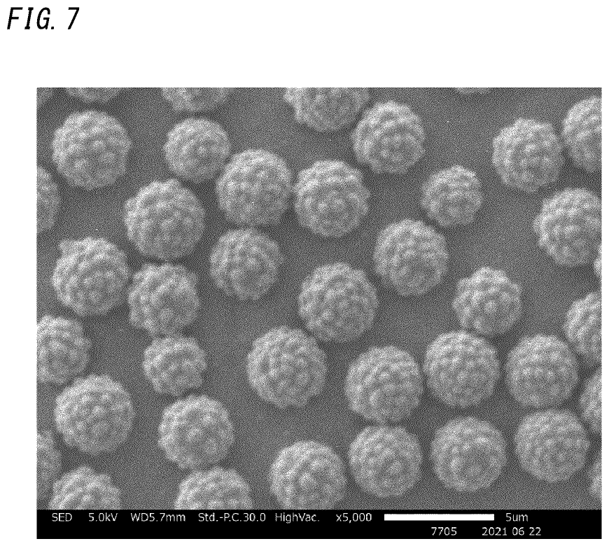

Particles of filler #1 (manufactured by NIKKO RICA CORPORATION, product name Silcrusta MKN03) were captured with a differential scanning electron microscope, thereby obtaining an image. The image is shown in FIG. 7. As shown in FIG. 7, each particle of filler #1 has projections on its entire surface. From the image, for 10 particles (the number of projections is more than 100 in total), the longitudinal diameter (dimension of the long diameter) of each projection and the transverse diameter (dimension in a direction orthogonal to the long diameter) were measured, and an average value of the longitudinal diameter and the transverse diameter was calculated as a diameter of the projection.

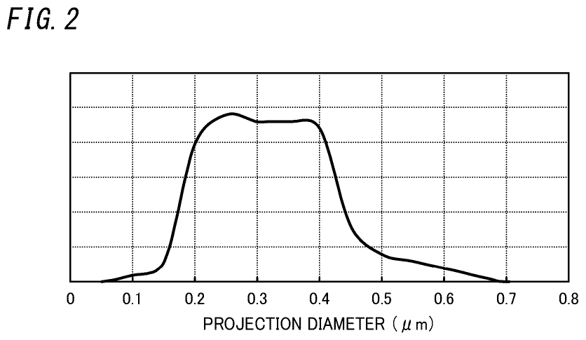

The result is shown in the graph of FIG. 2. In the graph, the horizontal axis represents the diameter of the projection, and the vertical axis represents the frequency (the number of projections). As the result shows, the frequency of the diameter of the projection of filler #1 is constantly high in the range from 200 nm to 500 nm.

### (2) Filler Comparative Evaluation

A mixture having the same composition as that in Example 1 except that no filler was included and filler #1 were mixed with each other such that the proportion of filler #1 was 40% by mass, thereby preparing a composition. Moreover, filler #3 (manufactured by NIKKO RICA CORPORATION, product name MSP-SN08), filler #4 (manufactured by NIKKO RICA CORPORATION, product name MSPTKN04), and filler #5 (manufactured by NIKKO RICA CORPORATION, product name NHRASN06) were used alternatively to filler #1, thereby preparing compositions in a similar manner.

Each of the compositions was applied to a glass slide by using a squeegee and was then cured by heating at 120° C. for 3 hours, thereby producing a cured material in film form having a thickness of 0.2 μm. The exterior of the cured material in the case of using filler #1 was visually checked, and it was found that gloss of a surface of the cured material in the case of using filler #1 was low as compared with the other cured materials.

Moreover, the average specular reflectance of a surface of each cured material was measured by the same method as that in “(4) 400-800 nm Average Specular Reflectance” of “2. Evaluation Test”. As a result, the average specular reflectance in the case of using filler #3 was 2.53%, the average specular reflectance in the case of using filler #4 was 2.18%, and the average specular reflectance in the case of using filler #5 was 1.70%, whereas the average specular reflectance in the case of using filler #1 was 0.14% and was thus significantly low.

### (3) Filler Blending Amount Evaluation

Compositions were prepared in a similar manner to that “(2) Filler Comparative Evaluation” except that the proportion of filler #1 in the compositions was changed to 0 volume %, 10 volume %, 20 volume %, 30 volume %, 32 volume %, and 35 volume %.

Each of the compositions was used to produce a cured material in film form in a similar manner to that “(2) filler comparative evaluation”.

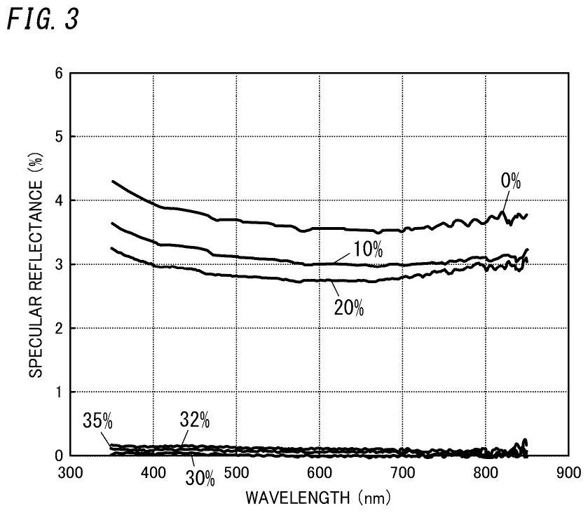

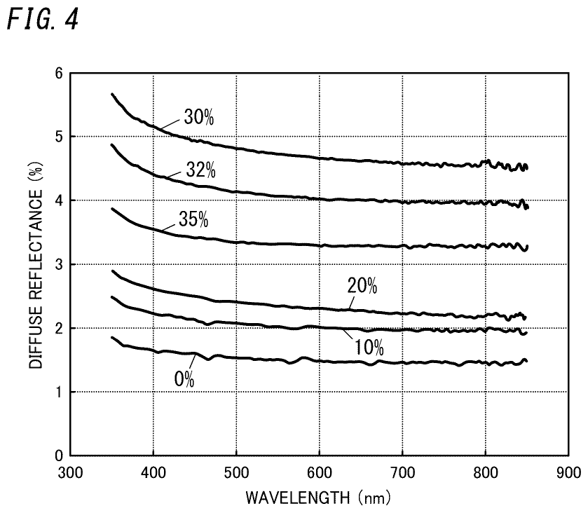

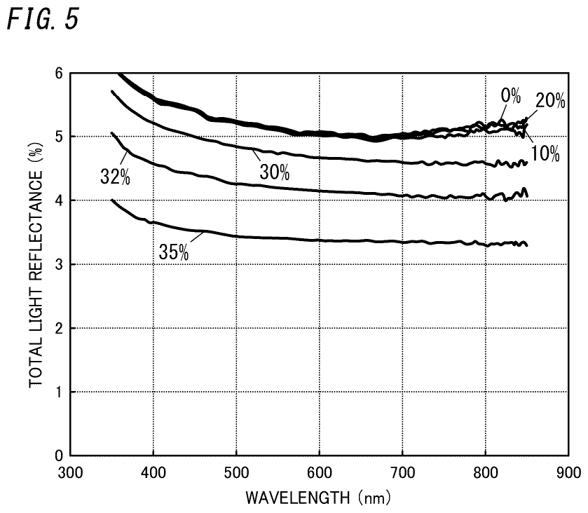

A specular reflectance spectrum and a diffuse reflectance spectrum of a surface of each cured material were respectively measured by the same methods as those in “(4) 400-8(0) nm Average Specular Reflectance” and “(6) 400-800 nm Average Diffuse Reflectance” of “2. Evaluation Test”. Moreover, for each cured material, a total light reflectance spectrum was obtained from the specular reflectance spectrum and the diffuse reflectance spectrum. The specular reflectance spectrum is shown in FIG. 3. The diffuse reflectance spectrum is shown in FIG. 4. The total light reflectance spectrum is shown in FIG. 5.

As the result shows, as the proportion of filler #1 increases, the specular reflectance decreases, and in particular, when the proportion of filler #1 changes from 20 volume % to 30 volume %, the specular reflectance drastically decreases. Moreover, as the proportion of filler #1 increases, the diffuse reflectance tends to increase, and in particular, when the proportion of filler #1 changes from 20 volume % to 30 volume %, the diffuse reflectance drastically increases, and the proportion of filler #1 further increases. This is presumably because when the proportion of filler #1 is 30 volume %, particles of filler #1 are exposed outside at the surface of the cured material, thereby dramatically increasing the diffusion of light by filler #1. Moreover, as the proportion of filler #1 increases, the total light reflectance deceases.

### (4) Surface Image of Cured Material

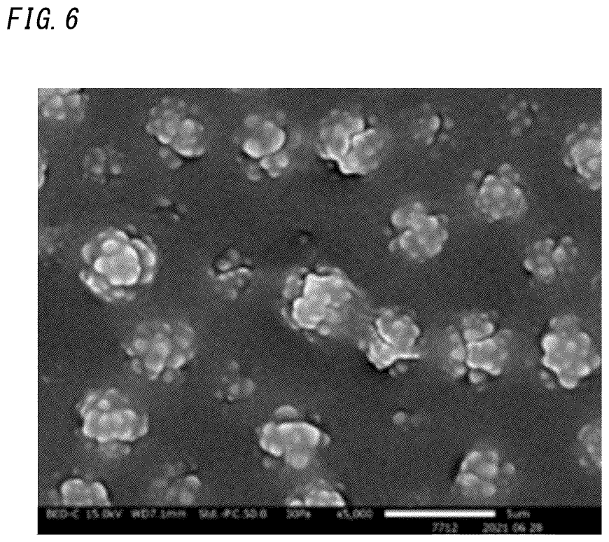

When the proportion of filler #1 in the composition in “(3) Filler Blending Amount Evaluation” is 30 volume %, an image obtained by capturing a surface of a cured material with a differential scanning electron microscope is shown in FIG. 6. According to this image, it can be confirmed that when the proportion of filler #1 is 30 volume %, the particles of filler #1 are exposed at the surface of the cured material.

1. A reaction curable composition comprising:
a reactive component (A); and
a filler (B),
the filler (B) containing an antireflection filler (B1),
the antireflection filler (B1) having an average particle size of greater than or equal to 0.8 μm and less than or equal to 10 μm, particles of the antireflection filler (B1) each having a surface having a plurality of projections,
a mean diameter of the plurality of projections being greater than or equal to 100 nm and less than or equal to 500 nm.

2. The reaction curable composition of claim 1, wherein
the antireflection filler (B1) is provided with the plurality of projections in a portion having an area of greater than or equal to 10% of the surface of each of the particles of the antireflection filler (B1).

3. The reaction curable composition of claim 1, wherein
the reactive component (A) contains a reactive compound (A1), and
the reactive compound (A1) contains at least one of an epoxy compound or an acryl compound.

4. The reaction curable composition of claim 3, wherein
the reactive component (A) further contains a curing agent (A2) which reacts with the reactive compound (A1).

5. The reaction curable composition of claim 3, further comprising an initiator (C).

6. The reaction curable composition of claim 1, wherein
a refractive index of the antireflection filler (B1) satisfies at least one of that the refractive index is less than or equal to 1.7 or that the refractive index is less than or equal to a refractive index of a cured material of the reactive component (A).

7. The reaction curable composition of claim 1, wherein
each of the particles of the antireflection filler (B1) is a core shell-type particle including a core and a shell covering the core and has the plurality of projections on a surface of the shell.

8. The reaction curable composition of claim 7, wherein
the core contains an acrylic resin, and the shell and each of the plurality of projections contain silicone.

9. The reaction curable composition of claim 1, wherein
a percentage of the filler (B) relative to the reaction curable composition is greater than or equal to 10 volume %.

10. The reaction curable composition of claim 1, wherein
an amount of the antireflection filler (B1) relative to 100 parts by mass of the reactive component (A) is greater than or equal to 5 parts by mass and less than or equal to 82 parts by mass.

11. The reaction curable composition of claim 1, further comprising a coloring material (D).

12. The reaction curable composition of claim 11, wherein
the coloring material contains at least one member selected from the group consisting of carbon black, black titanium oxide, zirconium nitride, and a dye.

13. The reaction curable composition of claim 11, wherein
an amount of the coloring material (D) relative to 100 parts by mass of the reactive component (A) is greater than 0 parts by mass and less than or equal to 10 parts by mass.

14. The reaction curable composition of claim 1, wherein
an average specular reflectance, measured by using an integrating sphere and at an incidence angle of 8°, of a cured material of the reaction curable composition for light in a wavelength range of greater than or equal to 400 nm and less than or equal to 800 nm is less than or equal to 0.5%.

15. The reaction curable composition of claim 1, wherein
a viscosity at 25° C., measured with a B-type rotary viscometer at 20 rpm, of the reaction curable composition is less than or equal to 200 Pa·s.

16. The reaction curable composition of claim 1, wherein
a thixotropic index which is a ratio of a viscosity at 25° C., measured with a B-type rotary viscometer at 2 rpm, of the reaction curable composition to a viscosity measured with the B-type rotary viscometer at 25° C. at 20 rpm is greater than or equal to 1 and less than or equal to 7.

17. The reaction curable composition of claim 1, wherein
an elastic modulus of a cured material of the reaction curable composition at −40° C. is less than or equal to 10 GPa.

18. The reaction curable composition of claim 1, wherein
the reaction curable composition contains no solvent or contains only a solvent inevitably mixed with the reaction curable composition as a solvent.

19. The reaction curable composition of claim 1, wherein
the reaction curable composition is an adhesive.

20. The reaction curable composition of claim 1, wherein
the reaction curable composition is a composition for underfill material production.
